(19) United States
(12) Patent Application Publication
(10) Pub. No.: US 2014/0014578 A1
(43) Pub. Date: Jan. 16, 2014

(54) Oscillatory crossflow membrane separation

(71) Applicant: Rockwater Resource, LLC, Denver, CO (US)

(72) Inventors: Reginald A. Wiemers, Littleton, CO (US); Kohlheb Robert, Cserszegtomaj (HU)

(73) Assignee: Rockwater Resource, LLC, Denver, CO (US)

(21) Appl. No.: 13/987,847

(22) Filed: Sep. 9, 2013

Related U.S. Application Data
(63) Continuation of application No. 12/452,774, filed on Jan. 22, 2010, now abandoned.

(51) Int. Cl. C02F 1/44

(52) U.S. Cl. CPC C02F 1/44
USPC 210/634; 210/321.72; 210/130

(57) ABSTRACT

Oscillatory crossflow membrane separation apparatus and methods are disclosed for effluent treatment. The apparatus include a membrane module with a housing containing a membrane element, said module having an input for receiving effluent for treatment and a treated effluent output. A crossflow pump is connected for moving oscillating fluid through the membrane module and a feed pressure pump is connected with the membrane module for applying membrane operating pressure. A fluid oscillator is active with either pump for pulsating fluid received thereat.

### RELATED APPLICATION

This Application is a Continuation of now pending U.S. patent application Ser. No. 12/452,774 filed Jan. 22, 2010 by the inventors herein and entitled Oscillatory Crossflow Membrane Separation, which prior application is a continuation of U.S. patent application Ser. No. 11/888,512 filed Aug. 1, 2007 by inventors including the inventors herein.

### FIELD OF THE INVENTION

This invention relates to effluent treatment, and, more particularly, relates to membrane separation apparatus.

### BACKGROUND OF THE INVENTION

Most industrial and municipal processes require water treatment facilities to treat effluents returned to the environment. Such facilities typically represent a significant investment by the business/community, and the performance of the facility (or failure thereof) can seriously impact ongoing operations financially and in terms of operational continuity.

Moreover, not all effluent treatment requires the same technologies. Industrial effluents (such as is found at coal bed methane facilities or oil production sites, for example) all have different particulate, pollutant and/or biomass content inherent to both the industrial processes as well as the particular water and soil conditions found at the site. Municipal requirements would likewise vary depending on desired end-of-pipe quality and use (and again depending on the feed water present at the site).

Membrane separation apparatus have been previously suggested and/or utilized. Such apparatus require frequent maintenance and cleaning or replacement of membrane elements fouled over time. Vibration of membranes has been suggested heretofore wherein a membrane module is tortionally vibrated. Such apparatus have typically required use of specially designed, single source (and thus expensive) membranes. In such designs, moreover, each membrane module requires its own vibratory energy source.

Therefore, improvements directed to such apparatus could still be utilized. Moreover, improved treatment technologies adapted to this and other uses can always be utilized given the criticality of provision and maintenance of clean water.

### SUMMARY OF THE INVENTION

This invention provides an oscillatory crossflow membrane separation apparatus and methods wherein membrane modules are not physically moved. The apparatus thus provides for less expensive membrane separation processing (reduced maintenance and replacement costs). Adequate shear in treatment of contaminated water to increase permeate continuity for feedwater having moderate colloidal loading is achieved. The apparatus employs vibratory membrane treatment without moving sensitive membrane elements or modules and associated components. This minimizes energy requirements while simultaneously increasing membrane longevity. Standard membrane elements modules/housings may be used.

The membrane separation apparatus of this invention includes a membrane module having a housing containing a membrane element, the module provide with an input for receiving effluent for treatment and a treated effluent output. A fluid oscillator pulsates fluid received thereat, and a crossflow pump is connected with the fluid oscillator and the membrane module input for moving oscillating fluid through the membrane module. In another embodiment of the apparatus, the crossflow pump is connected with the membrane module input for moving fluid through the membrane module. The fluid oscillator pulsates fluid applied by the feed pressure pump.

The methods of this invention include the steps of directing effluent fluid to be treated to a membrane separation module through a fluid feed line, applying fluid through a fluid pressure line at the membrane separation module to establish selected membrane pressure, and oscillating fluid in one of the feed line and the fluid pressure line.

It is therefore an object of this invention to provide provides an oscillatory crossflow membrane separation apparatus and methods wherein membrane modules are not physically moved

It is another object of this invention to provide an oscillatory crossflow membrane separation apparatus and methods that promotes less expensive membrane separation processing by reducing energy, maintenance and replacement costs.

It is another object of this invention to provide an oscillatory crossflow membrane separation apparatus and methods wherein adequate shear in treatment of contaminated water to increase permeate continuity for feedwater having moderate colloidal loading is achieved.

It is still another object of this invention to provide an oscillatory crossflow membrane separation apparatus and methods employing vibratory membrane treatment without moving sensitive membrane elements or modules and associated components.

It is yet another object of this invention to provide a membrane separation apparatus for effluent treatment that includes a membrane module including a housing containing a membrane element, the module having an input for receiving effluent for treatment and a treated effluent output, a fluid oscillator for pulsating fluid received thereat, and a crossflow pump connected with the fluid oscillator and the membrane module input for moving oscillating fluid through the membrane element.

It is another object of this invention to provide a membrane separation apparatus for effluent treatment including a membrane module including a housing containing a membrane element, the module having an input for receiving effluent for treatment and a treated effluent output, a crossflow pump connected with the membrane module input for moving fluid through the membrane element, a feed pressure pump connected with the membrane module for applying fluid establishing membrane pressure, and a fluid oscillator for pulsating fluid applied by the feed pressure pump.

It is yet another object of this invention to provide a method for vibratory membrane separation of an effluent fluid to be treated that includes the steps of directing effluent fluid to be treated to a membrane separation module through a fluid feed line, applying fluid through a fluid pressure line at the membrane separation module to establish selected membrane pressure, and oscillating fluid in one of the feed line and the fluid pressure line.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a diagram illustrating an oscillatory fluid column crossflow membrane separation system of this invention utilizable in primary treatment of effluents;

FIG. 2 is a diagram illustrating a vibratory retentate membrane separation system of this invention utilizable in primary treatment of effluents; and

FIG. 3 is a diagram illustrating another alternative oscillating retentate membrane separation system of this invention.

### DESCRIPTION OF THE INVENTION

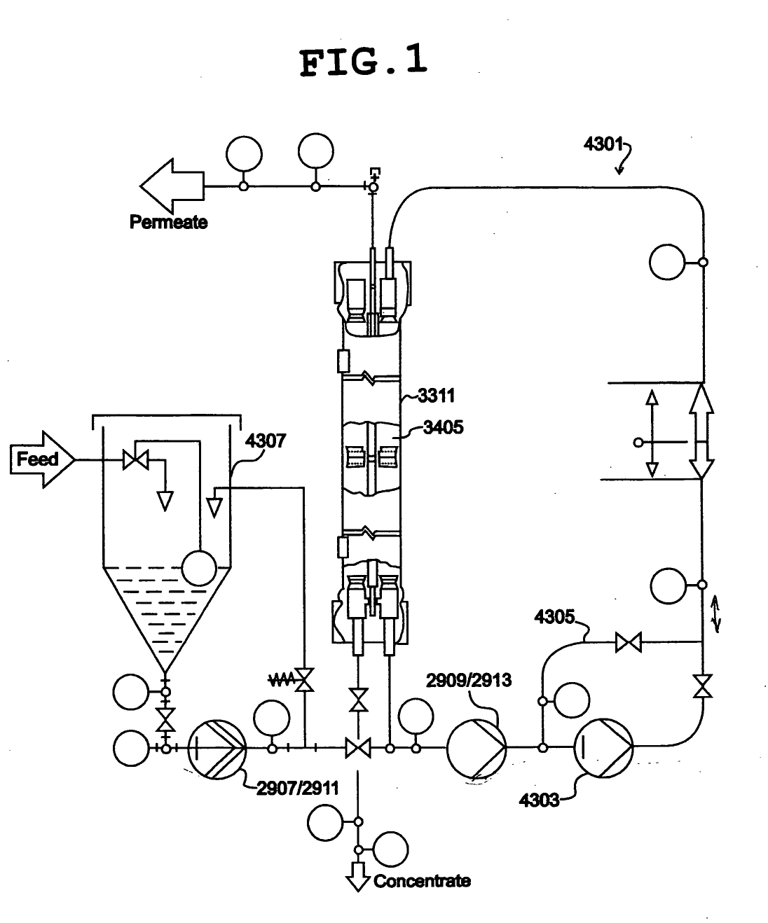

In accordance with another aspect of this invention, a first embodiment of a membrane separation apparatus and method utilizable with known membrane separation systems is shown in FIG. 1. This invention relates to apparatus and methods for fluid filtering utilizing membrane separation (for example nanofiltration and/or reverse osmosis filtration) that combines vibratory shear techniques with adjustable crossflow techniques. This and further embodiments of the membrane separation apparatus and methods (set forth hereinafter) are particularly well adapted to effluent (water) treatment options generically referred to hereinafter as membrane treatment systems (often typically high frequency applications are utilized).

High frequency membrane separation herein refers to vibrating, oscillatory motion relative to membrane elements. Vibration direction is perpendicular to the floor of an installation for gravity assisted membrane separation systems. The vibration curve is preferably a regular curve, which corresponds mathematically to a zero centered sine or cosine, a sinusoidal or simple harmonic. The amplitude is preferably steady and frequency high.

The shear wave produced by axial vertical vibration causes solids and foulants to be lifted off membrane surfaces and remixed with retentate flowing through the parallel or tunnel spacer or other specially designed spacers of spirally wound elements or through flow channels of tubular or capillar membrane elements. Movement continuity is maintained through the adjustable crossflow, reducing further additional membrane fouling tendency.

This hybrid approach using adjustable crossflow and high shear processing exposes membrane surfaces for maximum flux (volume of permeate per unit area and time) that is typically higher than the flux of conventional vibratory membrane technology alone. In the conventional vibratory membrane design, each membrane module requires its own vibratory energy source. Only a single vibratory source needs to be utilized for multi-membrane module designs (up to thirty-two 2.5″, sixteen 4″ or eight 8″ membrane modules).

FIGS. 1 through 3 illustrate the oscillatory crossflow membrane separation apparatus and methods of this invention. The apparatus and methods of this aspect of the invention achieve adequate shear in treatment of contaminated water to increase permeate continuity for feedwater having moderate colloidal loading. The apparatus employs vibratory membrane treatment without moving sensitive membrane elements 3405 or modules 3311 and associated components. This minimizes energy requirements while simultaneously increasing membrane longevity. Standard membrane elements 3405 and standard modules/housings 3311 may be used.

Thickness of the membrane boundary layer is affected by the permeate flux rate. However, oscillatory crossflow shear forces, together with a spacer introduced homogenization effect, reduces the size of the boundary layer by pulling suspended particles back. This, in turn, keeps them from settling and returns the particles to the bulk stream. The bulk stream contains the returned particles between the membrane leaves.

In apparatus/system 4301 oscillatory shear forces are provided by the pulsing crossflow medium itself, oscillatory crossflow pulsations generated by modified piston or diaphragm pump 4303 (for example, pumps from SPECK, WANNER, CAT, DANFOSS (Nessie), or others). Pump modification consists of the removal of the particular pump suction and discharge check valves.

This valveless pump 4303 provides no true pumping. Only an up and down, pulsating fluid column is generated by the valveless pump. Since valveless pump 4303 in apparatus 4301 does not function as an operational pump, it will be referred to hereinafter as a fluid oscillator. Since oscillator 4303 does not have to produce a high pressure gradient, its operating energy requirement is very low. Oscillation amplitude (height of the fluid column) depends on the relationship between the combined membrane flow channel displacement volume, geometric displacement volume of fluid column oscillator 4303, and membrane element 3405 length.

Crossflow movement of the oscillating fluid column over membrane element 3405 is provided by pump 2909/2913, for example. Valve controlled bypass 4305 is located between the discharge from crossflow recirculation pump 2909/2913 and after the discharge end of oscillator 4303 for purposes of bypassing oscillator 4303 and/or fine tuning the pulsation effect. System feed pressure is provided by high pressure pump 2907/2911.

Feed pressure pump 2907/2911 provides the applied membrane pressure after adjusting for the permeate pressure and, if applicable, for the osmotic pressure. Crossflow pump 2909/2913 provides a stream of prefiltered (as heretofore discussed and indicated generally herein at 4307) feed fluid passing over the surface of membrane element 3405 which flows perpendicular to the permeate stream. Oscillator 4303 provides the pulsating shear force effect to the combined flow volume of the other two pumps and operates in series with pump 2907/2911.

The primary application for apparatus 4301 and related methods is for membrane systems having small, combined membrane flow-channel displacement volume, wherein, despite a relatively small geometric displacement volume of fluid column oscillator 4303, an adequate oscillation amplitude height producing an effective shear action to minimize the thickness of the membrane boundary layer is produced. The methods and apparatus 4301 for oscillatory crossflow membrane separation can be applied whenever a crossflow, combined with a reduced permeate flux, is otherwise insufficient to reduce the boundary layer thickness. Upgrade and maintenance situations can make particularly effective use of apparatus 4301. Apparatus 4301 would also be useful in treatment settings where the medium to be treated shows a high scale formation potential caused by high concentration of dissolved salts.

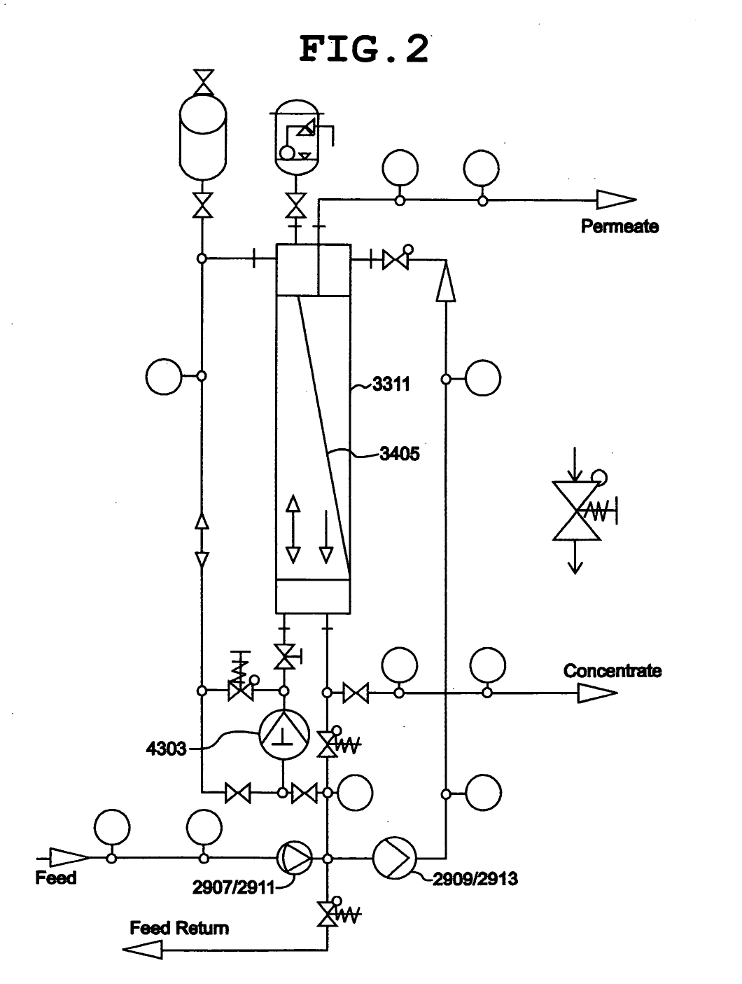

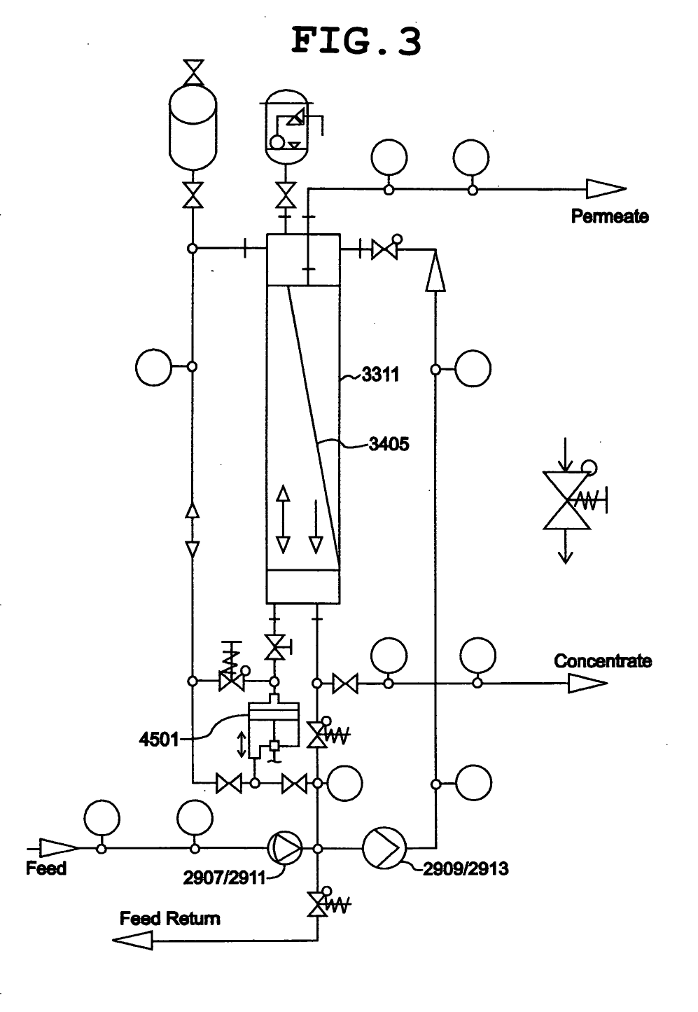

FIG. 2 shows an operating principle variation of the system shown in FIG. 1. In this embodiment, oscillator 4303 works against pump 2907/2911. This embodiment is particularly useful if the medium to be treated shows a high fouling potential caused by suspended solids of colloidal matter and organics. FIG. 3 shows yet another variation of the system shown in FIG. 1. Fluid column oscillation is provided by double-acting cylinder system 4501 with a single piston. The piston is powered by an electrical crankshaft drive. The double-acting cylinder system enhances the fluid column oscillation over the entire membrane.

In operation, during a piston upstroke in oscillator 4303/4501, the fluid column within the leaves of membrane element 3405 is accelerated upwards, the upward movement starting at the discharge end of membrane element 3405. The pneumatic accumulator of a standard membrane module 3311 acts as a hydraulic balancer in the system of this aspect of the invention. Air pressure in the accumulator acts as a weight for raising the piston by pushing the stand pipe's fluid column against the bottom side (rod side) of the piston thus assisting the column's upward movement over the entire membrane length and minimizing slip and localized hydroshock. Piston friction is reduced allowing for high oscillating frequency operation.

During a piston downstroke in oscillator 4303/4501, the fluid column within the leaves of membrane element 3405 is accelerated downward, the downward movement starting at the discharge end of the membrane. The momentary void at the lead end of membrane element 3405 is augmented by the stored energized volume from the hydropneumatic accumulator, thus providing an uninterrupted downward movement of the fluid column over the entire membrane length and minimizing slip and localized cavitation.

The pneumatic accumulator of module 3311 also serves as a water hammer and surge pressure absorber (shock dampener). The internal hydromechanical shock vibrations introduced by the oscillator 4303/4501 could cause damages to membrane element 3405. The accumulator dampens these hydromechanical shocks without reducing significantly the adequacy of hydromechanical shear to the boundary thickness layer of element 3405.

In general, apparatus 4301 works with a low crossflow velocity. In order to secure a reversal in shear direction and produce a useful shear velocity, the crossflow velocity must be lower than the fluid column oscillation velocity. The fluid column up-stroke works against the downward directed crossflow. The oscillatory axial crossflow membrane separation apparatus and method of FIGS. 1 through 3, when compared to non-oscillating conventional crossflow membrane systems operating at a standard crossflow velocity of 1 m/s, reveals that these new oscillatory apparatus produce higher shear rates by a magnitude due to motional fluid acceleration. The oscillatory crossflow membrane separation method of this invention produces approximately five times greater a shear rate with the up-stroke, and approximately 14 times greater a shear rate with the down-stroke oscillation than the conventional crossflow membrane separation systems.

As may be appreciated from the foregoing, apparatus and methods are provided for oscillatory crossflow membrane separation wherein vibratory membrane treatment is achieved without moving sensitive membrane elements or modules and associated components, thus minimizing energy requirements while simultaneously increasing membrane longevity. Standard membrane elements and modules/housings may be used in the apparatus.

What is claimed is:

1. A crossflow membrane separation apparatus for effluent treatment comprising:
a first membrane module including a housing containing a membrane element, said module having a feed pressure input, a crossflow input, and a treated effluent output;
a feed pressure pump connected with said feed pressure input of said first membrane module for applying membrane operating pressure;
a fluid oscillator for pulsating fluid received thereat to provide both up-stroke and down-stroke oscillations; and
a crossflow pump connected with said crossflow input of said first membrane module, said fluid oscillator connected for pulsating flow volume from said feed pressure pump and said crossflow pump providing up-stroke shear rate about five times greater and down-stroke shear rate about 14 times greater than conventional crossflow membrane separation systems.

2. The apparatus of claim 1 wherein said crossflow pump is connected with said fluid oscillator.

3. The apparatus of claim 1 wherein said fluid oscillator is a valveless pump.

4. The apparatus of claim 1 further comprising a feed fluid filter receiving effluent for treatment and outputting filtered feed fluid to said crossflow pump.

5. The apparatus of claim 1 further comprising a valve controlled bypass located between said crossflow pump and after said crossflow input for controllably bypassing said fluid oscillator and adjusting oscillatory effect.

6. The apparatus of claim 1 wherein said fluid oscillator is connected to work against said feed pressure pump.

7. The apparatus of claim 1 wherein said fluid oscillator is a double-acting cylinder system having a single piston.

8. The apparatus of claim 1 wherein said crossflow pump and said crossflow input of said first membrane module are configured to provide a liquid stream flowing perpendicular to a treated effluent stream at said first membrane module.

9. The apparatus of claim 1 further comprising at least a second membrane module and wherein said fluid oscillator is connected for pulsating flow at both of said first and said second modules.

10. A membrane separation apparatus for effluent treatment comprising:
a membrane module including a housing containing a membrane element, said membrane module having an effluent input for receiving effluent for treatment and a treated effluent output;
a crossflow pump connected with said effluent input of said membrane module introducing a liquid stream at said membrane element;
a feed pressure pump connected with said membrane module for applying membrane operating pressure; and
a fluid oscillator connected with said crossflow pump and established to pulsate fluid in said membrane module providing shear rates at said membrane element up to about five to 14 times greater than conventional crossflow membrane separation systems.

11. The apparatus of claim 10 wherein said fluid oscillator is one of a piston pump or diaphragm pump.

12. The apparatus of claim 10 wherein said membrane module includes a pneumatic accumulator connected with said fluid oscillator for balancing operation of said apparatus.

13. The apparatus of claim 10 further comprising crossflow adjustment at said crossflow pump to control fluid movement continuity.

14. A method for vibratory membrane separation of an effluent fluid to be treated comprising the steps of:
directing effluent fluid to be treated to a membrane separation module having a membrane element oriented so that a fluid column is defined therein, the effluent fluid directed through a fluid feed line at a selected feed velocity providing an effluent stream at a first selected flow volume;
applying fluid through a fluid pressure line at said membrane separation module to establish selected membrane operating pressure at a second selected flow volume; and
oscillating fluid at one of said lines or said membrane separation module at a selected fluid oscillation velocity greater than said selected feed velocity thereby providing up-stroke and down-stroke oscillations for pulsating combined said first and said second flow volumes of said fluids directed and applied through said lines, said down-stroke oscillations having a shear rate greater than shear rate of said up-stroke oscillations.

15. The method of claim 14 wherein the step of oscillating fluid includes providing adequate oscillation amplitude height to produce effective said shear rates between about 5 and 14 times conventional crossflow membrane separation methods.

16. The method of claim 14 wherein the step of oscillating fluid includes providing adequate oscillation amplitude height to produce effective shear thus deterring excess scale formation.

17. The method of claim 14 wherein the step of oscillating fluid includes fluid pumping.

18. The method of claim 14 wherein fluid in the membrane element fluid column is oscillated at said selected oscillation velocity, the step of applying fluid through a fluid pressure line at said membrane separation module to establish selected membrane operating pressure further comprising producing a low pressure gradient across said membrane element.

19. The method of claim 14 wherein said down-stroke oscillations shear rate is at least twice the shear-rate of said upstroke oscillations.

20. The method of claim 19 wherein said fluid received at said module from said feed line is downwardly directed in said module and said oscillation of fluid at said fluid column is in an up and down direction in said module.
